(19) United States
(12) Patent Application Publication
(10) Pub. No.: US 2026/0293838 A1
(43) Pub. Date: Oct. 1, 2026

(54) BEDDING MACHINE

(71) Applicant: Nuhn Industries Ltd., Sebringville (CA)

(72) Inventor: Ian NUHN, Stratford (CA)

(73) Assignee: Nuhn Industries Ltd., Sebringville (CA)

(21) Appl. No.: 19/636,358

(22) Filed: Apr. 1, 2026

Related U.S. Application Data
(60) Provisional application No. 63/781,735, filed on Apr. 1, 2025.

(51) Int. Cl. A01K 1/015

(52) U.S. Cl. CPC A01K 1/0156

(57) ABSTRACT

A bedding machine for distributing bedding material has: a frame; wheels rotatably mounted on the frame to permit the bedding machine to travel on the ground; a hopper supported on the frame, the hopper configured to contain bedding material; a tongue mounted on the frame extending longitudinally forward of the hopper in a direction of motion of the bedding machine; and, a distribution conveyor situated below the tongue and pivotably mounted to the frame, to the tongue or to both the frame and the tongue, the distribution conveyor configured to receive the bedding material from the hopper and to distribute the bedding material transversely to the direction of motion of the bedding machine.

### CROSS-REFERENCE TO RELATED APPLICATIONS

This application claims the benefit of U.S. Ser. No. 63/781,735 filed Apr. 1, 2025, the entire contents of which are herein incorporated by reference.

### FIELD

This application relates to agriculture, in particular to bedding machines for distributing bedding material to stalls in a barn.

### BACKGROUND

For efficient distribution of bedding material (e.g., wood shavings, straw and the like) to stalls in an animal barn, a bedding machine is used. Bedding machines are typically towable by a prime mover (e.g., a tractor) and comprise a hopper for containing the bedding material and a distributor for distributing the bedding material from the hopper into the stall. Space constraints in a barn place design constraints on the bedding machine for achieving maximum maneuverability, storage capacity for bedding material, and ability to tow the bedding machine with a smaller prime mover.

There remains a need for a bedding machine that provides one or more of improved maneuverability, storage capacity and towability.

### SUMMARY

A bedding machine for distributing bedding material comprises: a frame; wheels rotatably mounted on the frame to permit the bedding machine to travel on the ground; a hopper supported on the frame, the hopper configured to contain bedding material; a tongue mounted on the frame extending longitudinally forward of the hopper in a direction of motion of the bedding machine; and, a distribution conveyor situated below the tongue and pivotably mounted to the frame, to the tongue or to both the frame and the tongue, the distribution conveyor configured to receive the bedding material from the hopper and to distribute the bedding material transversely to the direction of motion of the bedding machine.

A bedding machine for distributing bedding material comprises: a frame; wheels rotatably mounted on the frame to permit the bedding machine to travel on the ground; a hopper supported on the frame, the hopper configured to contain bedding material, the hopper comprising an inclined live floor sloping downwardly from a front to a rear of the hopper; a tongue mounted on the frame extending longitudinally forward of the hopper in a direction of motion of the bedding machine; and, a distribution conveyor pivotably mounted to the frame, to the tongue or to both the frame and the tongue, the distribution conveyor configured to receive the bedding material from the hopper and to distribute the bedding material transversely to the direction of motion of the bedding machine.

In some embodiments, the distribution conveyor comprises an endless belt oriented transversely to the direction of motion of the bedding machine. In some embodiments, the endless belt is mounted on rollers, at least one of which is a drive roller driven by a distribution conveyor motor, for example a reversible hydraulic motor so that the bedding material can be distributed to either side of the bedding machine. In some embodiments, the distribution conveyor comprises two motors, one for driving the endless belt in one direction and another for driving the endless belt in another direction. The distribution conveyor is situated below the tongue. The distribution conveyor is pivotal about a longitudinal axis. Pivoting around a longitudinal axis provides a teeter-totter effect in which so that transverse ends of the distribution conveyor translate up and down, thereby facilitating distribution of the bedding material on one side or the other of the bedding machine. In some embodiments, the distribution conveyor is mounted on the frame. In some embodiments, the distribution conveyor is mounted on the tongue. In some embodiments, the distribution conveyor is mounted on the frame and the tongue. In some embodiments, the distribution conveyor is pivotably supported on a mounting shaft, the mounting shaft connected to the tongue, the frame or both the tongue and the frame.

In some embodiments, the wheels comprise two or more wheels. In some embodiments, the wheels comprise two wheels, one on each side of the frame. In some embodiments, the wheels comprise four wheels, two on each side of the frame. In some embodiments, the wheels comprise tandem wheels. In some embodiments, wheels opposed to each other across the frame are on a common axle. In some embodiments, wheels opposed to each other across the frame are on independent axles.

In some embodiments, the tongue comprises a pivotable tongue portion that is pivotal about a vertical rotation axis. In some embodiments, the tongue comprises a fixed tongue portion mounted to the frame and extending longitudinally forward of the hopper. In some embodiments, the pivotable tongue portion is pivotally connected to the fixed tongue portion at the vertical rotation axis. The pivotal tongue portion facilitates maneuverability. In some embodiments, a distance from an end of the tongue to a transverse centerline between the tandem wheels provides articulation of the bedding machine during turning, which facilitates maneuverability. In some embodiments, the tongue comprises a 2-point hitch. In some embodiments, the geometry of the 2-point hitch allows the bedding machine to follow the prime mover without cutting corners, which contributes to improved maneuverability. In some embodiments, the 2-point hitch is situated higher from the ground than the distribution conveyor during operation of the bedding machine. The 2-point hitch also permits the use of smaller sized and/or lower horse powered prime movers, for example quads, garden tractors and the like because there is less likelihood of overloading the hitch on such smaller sized or lower horse-powered prime movers.

The bedding machine comprises a hopper configured to contain bedding material. Bedding material includes, for example, wood shavings, straw and the like. In some embodiments, the hopper comprises a live floor and walls surrounding the floor. A live floor is a floor that contains a conveyor chain (belt) configured to transport the bedding material along the floor to a front of the hopper where a gate is situated. The conveyor chain comprises an endless chain on rollers and is operated by a chain motor that drives a drive roller. The bedding material is transported through the gate, out of the hopper where the bedding material is deposited on the distribution conveyor situated outside the hopper and below the tongue. The distribution conveyor conveys the bedding material to a side of the bedding machine for distribution to stalls. In some embodiments, the hopper is wider at a front than a rear of the hopper, which reduces the chance of the bedding material bridging at the gate.

The height of the conveyor from the ground is a fixed height that needs to clear the heugh of the stall entrance and needs to clear the height of an alley scraper. In some embodiments, the hopper comprises an inclined live floor sloping downwardly from a front to a rear of the hopper. In some embodiments, the floor of the hopper is inclined at an angle in a range of 3-15° for example about 10°. In some embodiments, the floor of the hopper is inclined at an angle in a range of 3-7°, for example about 5°. Inclining the floor downward from front to back reduces bridging of the bedding material in the hopper and additionally increases storage capacity of the hopper in the same footprint.

In some embodiments, the bedding machine further comprises a power-take-off (PTO) extending longitudinally forward of the tongue. In some embodiments, the power-take-off has a longitudinal centerline that is above the distribution conveyor during operation of the bedding machine. The PTO is operably connectable, either directly or through a shaft, to a corresponding PTO on the prime mover to obtain power from the prime mover. The PTO is operably connected to a closed hydraulic system on the bedding machine to supply power to a hydraulic pump that operates various hydraulic motors, for example the distribution conveyor motor and the chain motor. During operation of the bedding machine, the PTO is always straight.

The bedding machine is connectable through the 2-point hitch to a prime mover, for example a tractor, a truck, a quad or the like, which tows the bedding machine during operation of the bedding machine. The bedding machine has improved maneuverability (e.g., better turning radius), larger storage capacity in the hopper for bedding material and improved towability by less powerful prime movers, for example quads, garden tractors and the like. The bedding machine has a larger storage capacity at least in part due to the sloped hooper floor, the widening of the hopper toward the front and the placement of the conveyor below the tongue. While having a larger storage capacity, the overall dimensions of the bedding machine remain small resulting in an improved size-to-capacity ratio. The 2-point hitch, along with the pivoting tongue portion, contribute to the improved maneuverability.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a front side top perspective view of a first embodiment of a bedding machine.

FIG. 2 depicts a left side view of the bedding machine of FIG. 1.

FIG. 3 depicts a right side view of the bedding machine of FIG. 1.

FIG. 4 depicts a top view of the bedding machine of FIG. 1.

FIG. 5 depicts a bottom view of the bedding machine of FIG. 1.

FIG. 6 depicts a front top perspective view of the bedding machine of FIG. 1.

FIG. 7 depicts a front bottom perspective view of the bedding machine of FIG. 1.

FIG. 8 depicts a rear top perspective view of the bedding machine of FIG. 1.

FIG. 9 depicts a left side section view of the bedding machine of FIG. 1.

FIG. 10 depicts a magnified left side section view of the bedding machine of FIG. 1.

FIG. 11 depicts a front left side top perspective view of a second embodiment of a bedding machine.

FIG. 12 depicts a front right side top perspective view of the bedding machine of FIG. 11.

FIG. 13 depicts a rear left side top perspective view of the bedding machine of FIG. 11.

FIG. 14 depicts a rear right side top perspective view of the bedding machine of FIG. 11.

FIG. 15 depicts a left side view of the bedding machine of FIG. 11.

FIG. 16 depicts a right side view of the bedding machine of FIG. 11.

FIG. 17 depicts a top view of the bedding machine of FIG. 11.

FIG. 18 depicts a front view of the bedding machine of FIG. 11.

FIG. 19 depicts a rear view of the bedding machine of FIG. 11.

FIG. 20 depicts a right side cross-sectional view of the bedding machine of FIG. 11.

### DETAILED DESCRIPTION

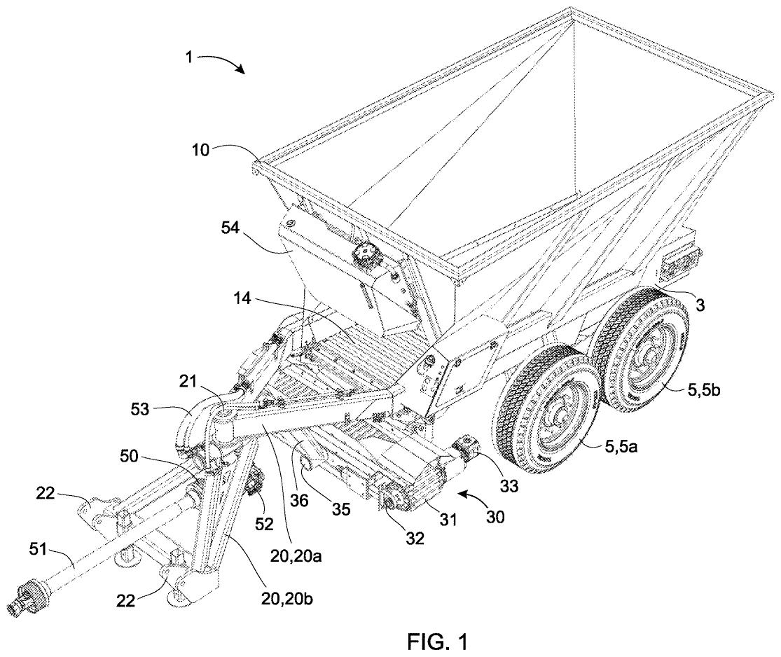

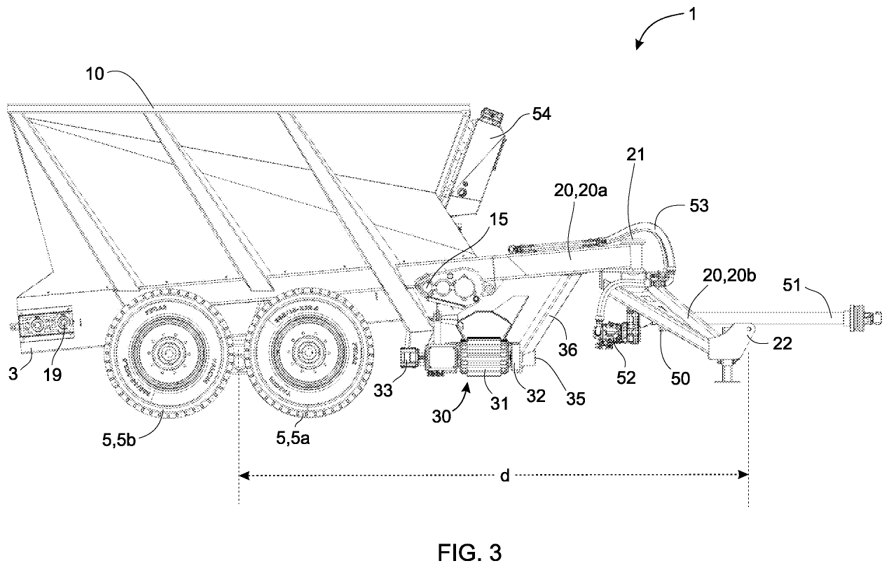

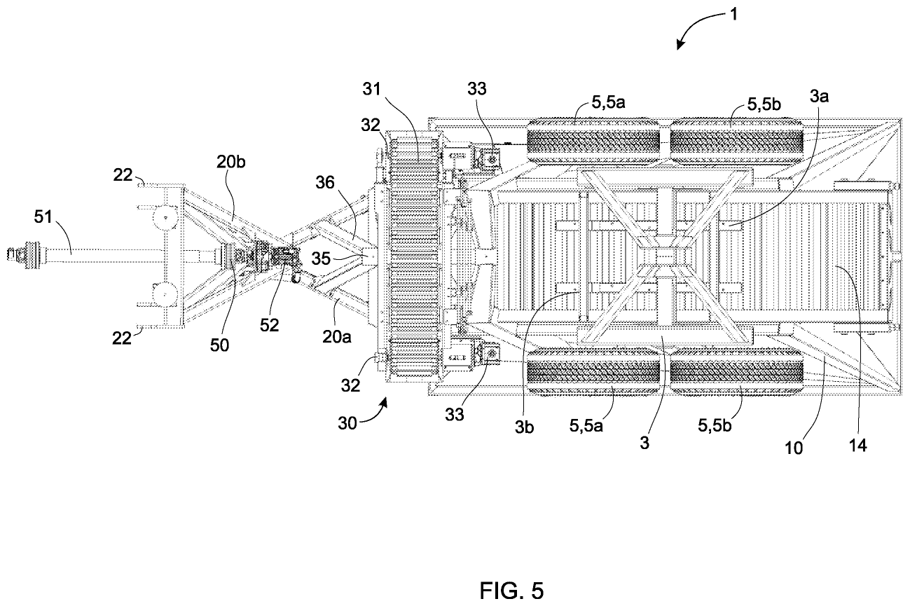

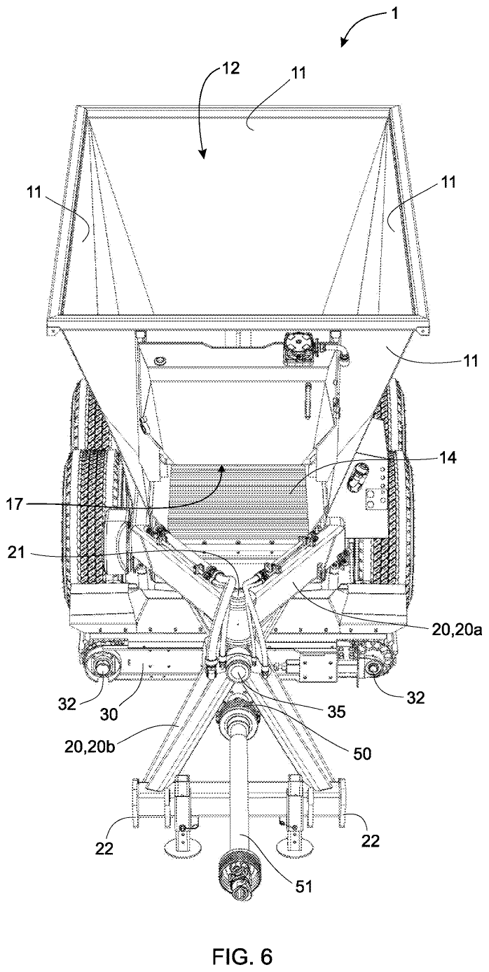

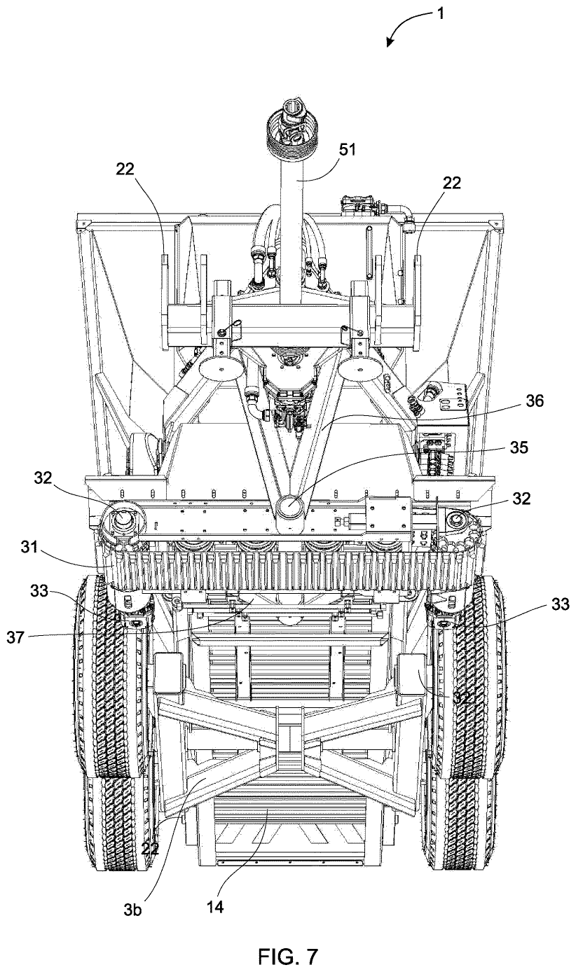

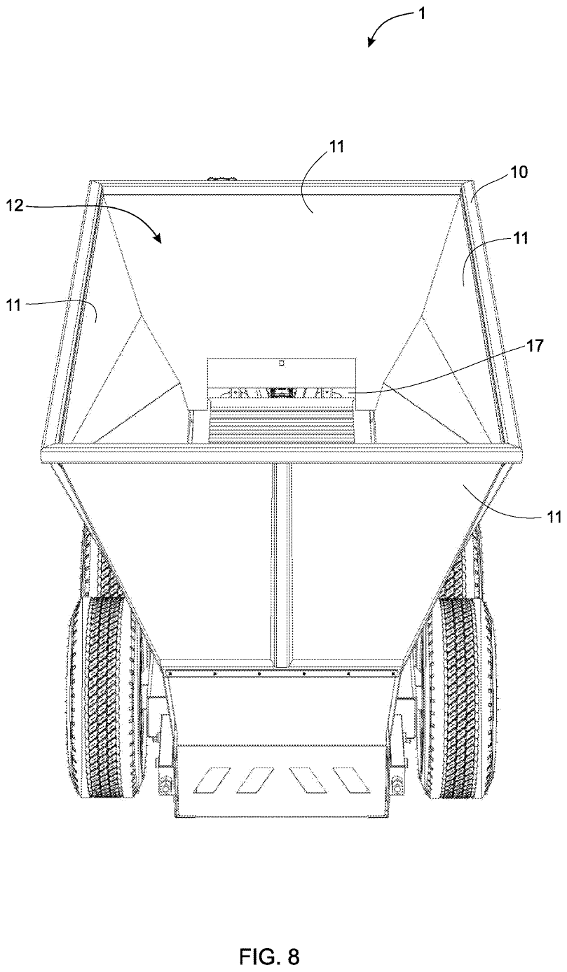

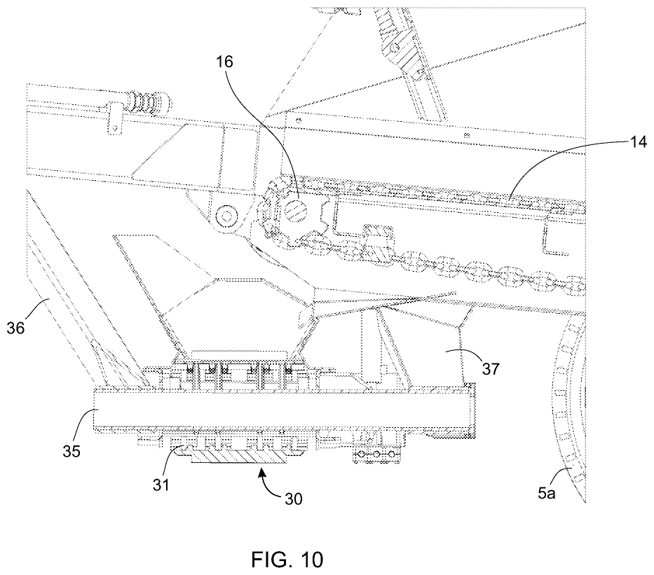

With reference to FIG. 1 to FIG. 10, a first embodiment of a bedding machine 1 for distributing bedding material to a stall comprises a frame 3, the frame 3 comprising a plurality of longitudinal 3a and transverse 3b frame elements on which various components of the bedding machine 1 are supported. Rotatably mounted on the frame 3 are wheels 5 arranged in tandem so that a set of two transversely opposed wheels 5a is forward of another set of two transversely opposed wheels 5b. The wheels 5 support the bedding machine 1 on the ground and permit the bedding machine 1 to travel easily on the ground.

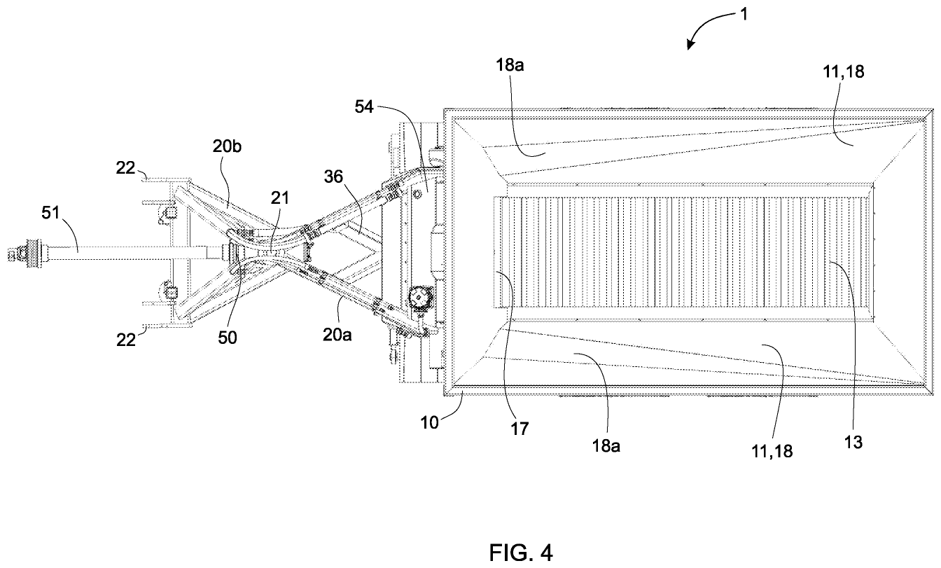

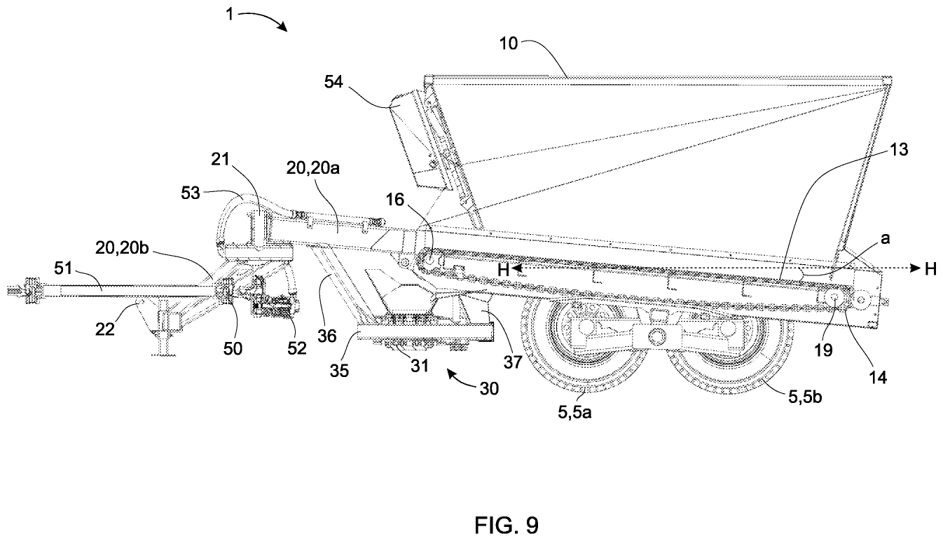

The bedding machine 1 further comprises a hopper 10 mounted on the frame 3. The hopper 10 comprises four walls 11, an open top 12 and a floor 13. The floor 13 is a live floor meaning the floor 13 is comprised of an upper surface of an endless conveyor chain 14 looped around a drive roller 16 at a front end and an idler roller 19 at a rear end of the conveyor chain 14. The conveyor chain 14 is driven by a hydraulic chain motor 15 operatively connected to a drive roller 16 of the conveyor chain 14. The conveyor chain 14 is driven so that bedding material in the hopper 10 is carried toward a gate 17 at a front of the hopper 10. As best seen in FIG. 9, the live floor 13 is inclined at an inclination angle a away from horizontal H-H, the inclination angle a being about 5°. The live floor 13 slopes downward from the front to a rear of the hopper 10. Furthermore, the sidewalls 18 of the hopper 10 (see FIG. 4) have transversely sloping sections 18a, which slope outward closer to the front of the hopper 10 thereby effectively increasing a width of the hopper 10 at the front of the hopper 10 as compared to the rear of the hopper 10. The increased width at the front of the hopper 10 reduces bridging of the bedding material in the hopper 10 at the gate 17 and additionally increases storage capacity of the hopper 10 in the same footprint.

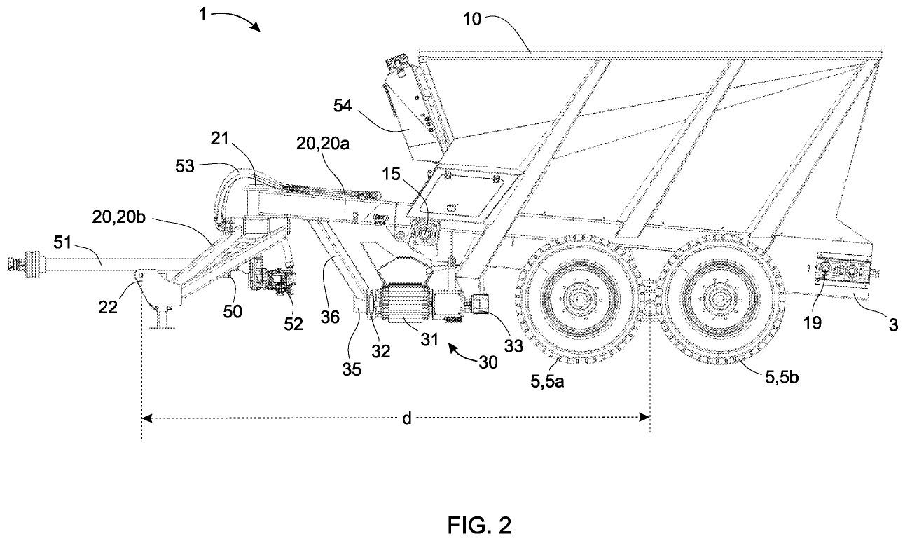

The bedding machine 1 further comprises a tongue 20 mounted on the frame 3 and extending longitudinally forward in a direction of motion of the bedding machine 1. The tongue 20 comprises a fixed tongue portion 20a fixedly mounted on the frame 3 and a pivotal tongue portion 20b pivotably mounted to the fixed tongue portion 20a at a pivot 21 so that the pivotal tongue portion 20b can pivot about a vertical rotation axis at the pivot 21. The pivotal tongue portion 20b extends longitudinally away from the fixed tongue portion 20a, the pivotal tongue portion 20b comprising two arms, each arm terminating in a hitch, the two hitches forming a 2-point hitch 22. A distance d from an end of the tongue 20 to a transverse centerline between the tandem wheels 5 (see FIG. 2) provides articulation of the bedding machine 1 around the pivot 21 for smooth turning of the bedding machine 1 in a tight turn radius.

The bedding machine 1 further comprises a distribution conveyor 30 suspended beneath the tongue 20. The distribution conveyor 30 is oriented transversely and comprises an endless belt 31 looped around two end rollers 32. Each end roller 32 is connected to its own hydraulic motor 33 so that operation of one of the hydraulic motors 33 drives the endless belt 31 in one transverse direction while operation of the other hydraulic motor 33 drives the endless belt 31 in the other transverse direction. The distribution conveyor 30 is pivotably mounted on a longitudinally oriented mounting shaft 35, the mounting shaft 35 mounted to the fixed tongue section 20a by struts 36 and to the frame 3 by struts 37. The mounting shaft 35 extends through a bore at the center of the distribution conveyor 30 between upper and lower portions of the endless belt 31 so that transverse ends of the distribution conveyor 30 can translate up and down to tip the distribution conveyor 30 left and right. The upper surface of the endless belt 31 receives the bedding material that drops down from the conveyor chain 14 as the conveyor chain 14 delivers the bedding material from the hopper 10 through the gate 17.

The bedding machine 1 further comprises a power-take-off (PTO) 50 connectable to a corresponding PTO of a prime mover through a PTO shaft 51. The PTO shaft 51 extends longitudinally forward from the tongue 20 and the PTO 50 is operatively connected to a hydraulic pump 52, which is mounted on the pivotal tongue portion 20b of the tongue 20. By virtue of being effectively mounted on the pivotal tongue portion 20b, the PTO shaft 51 remains straight throughout turning of the bedding machine 1. The hydraulic pump 52 is fluidly connected through hydraulic fluid lines 53 (only one labeled) to a hydraulic fluid reservoir 54 mounted on an exterior of the hopper 10 and to the various hydraulic motors 15 and 33 used to operate the conveyor chain 14 and the distribution conveyor 30, respectively. As best seen in FIG. 2, the distribution conveyor 30 is below both the tongue 20 and the PTO shaft 51 when the bedding machine 1 is operating.

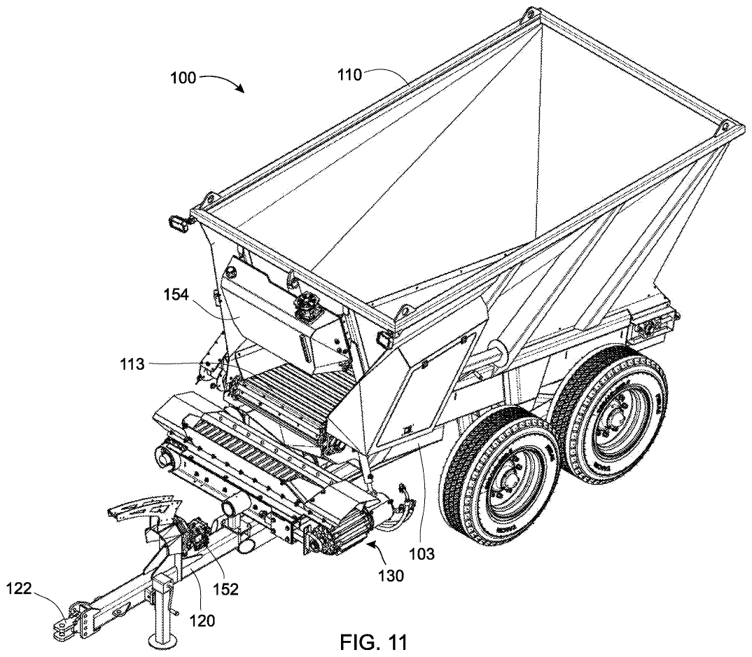

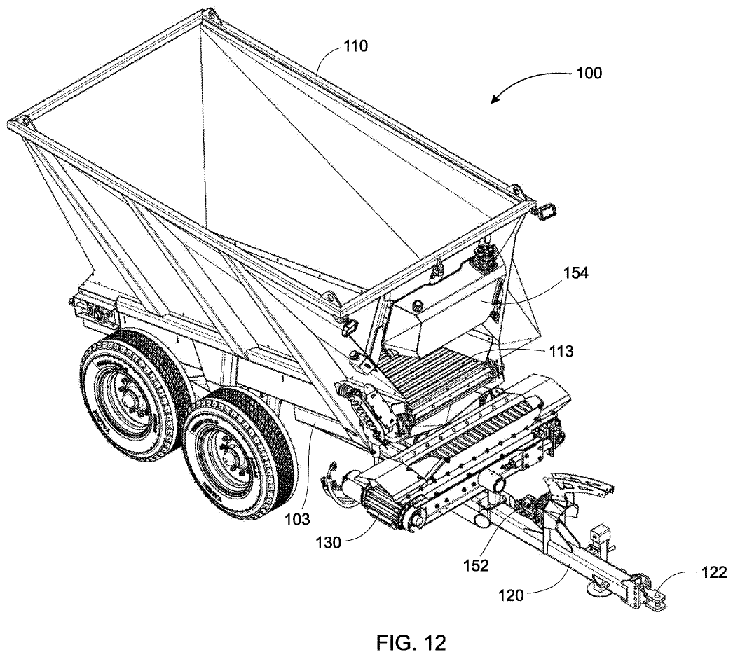

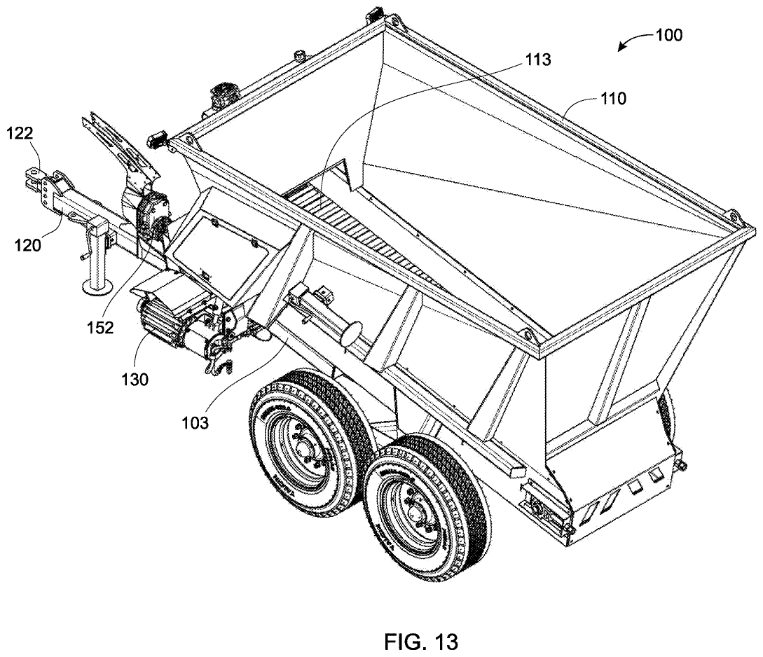

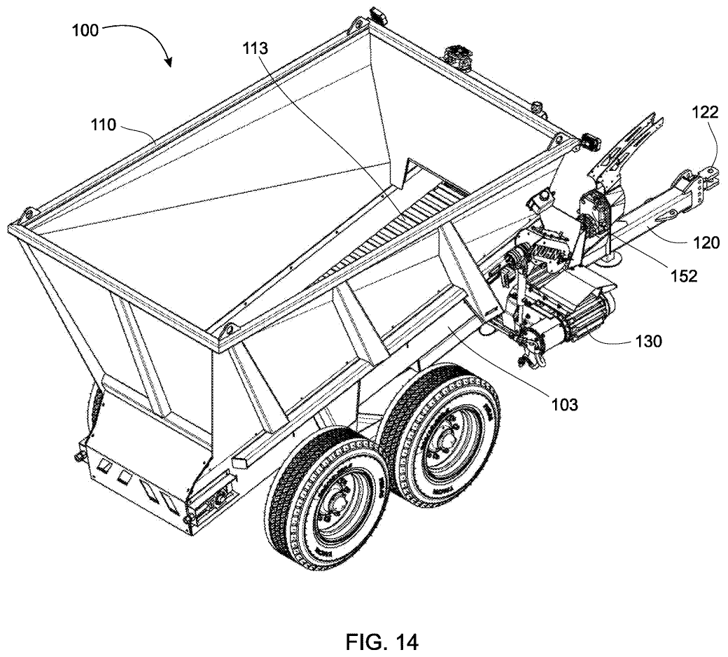

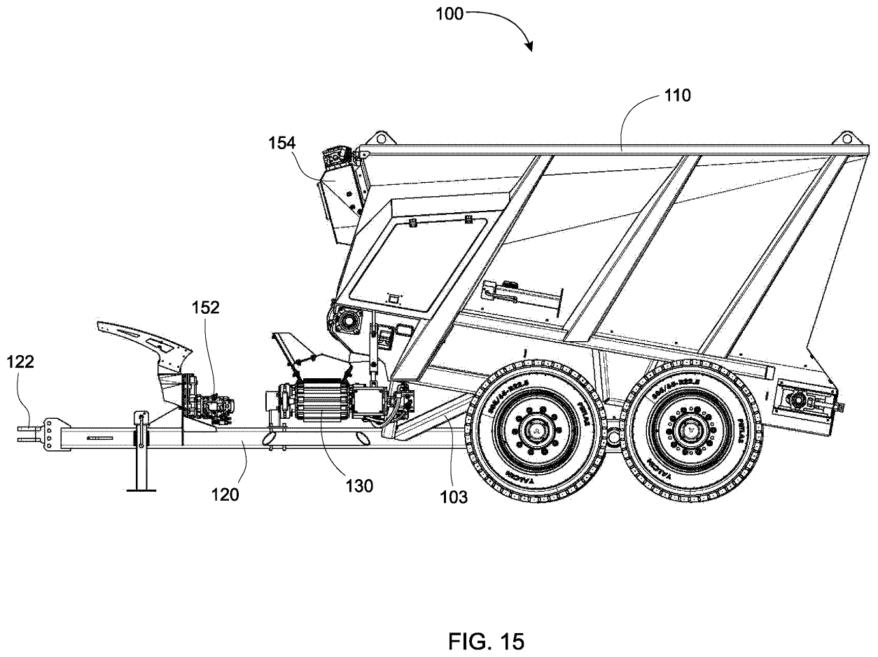

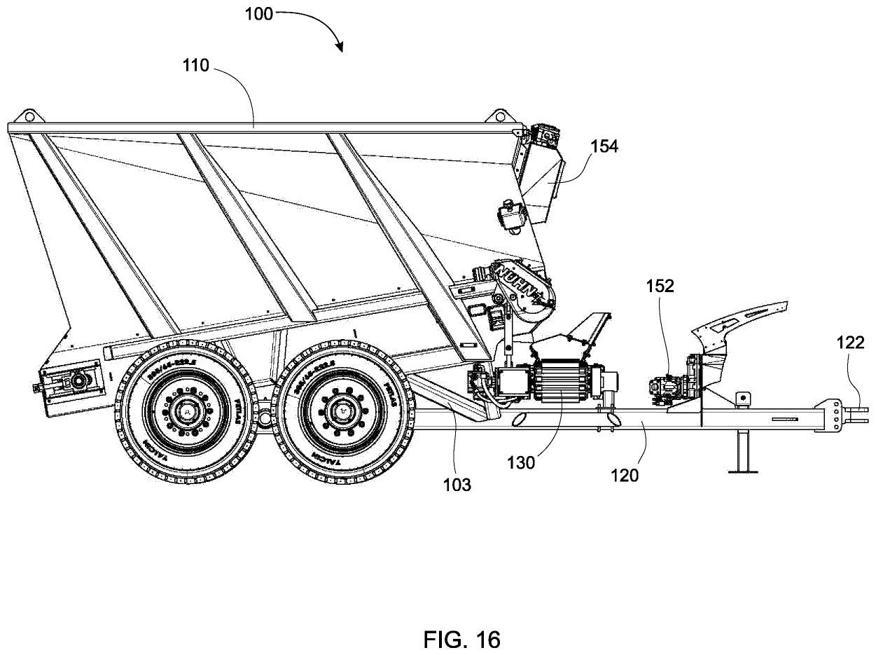

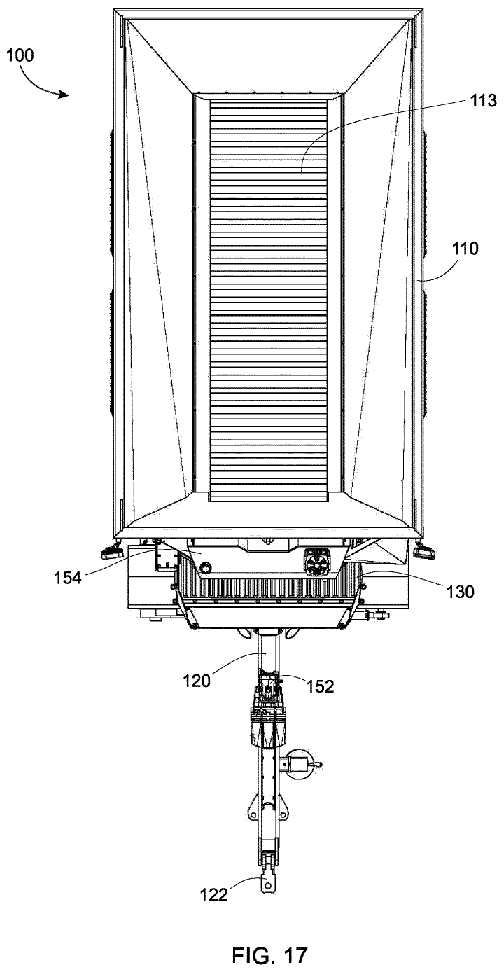

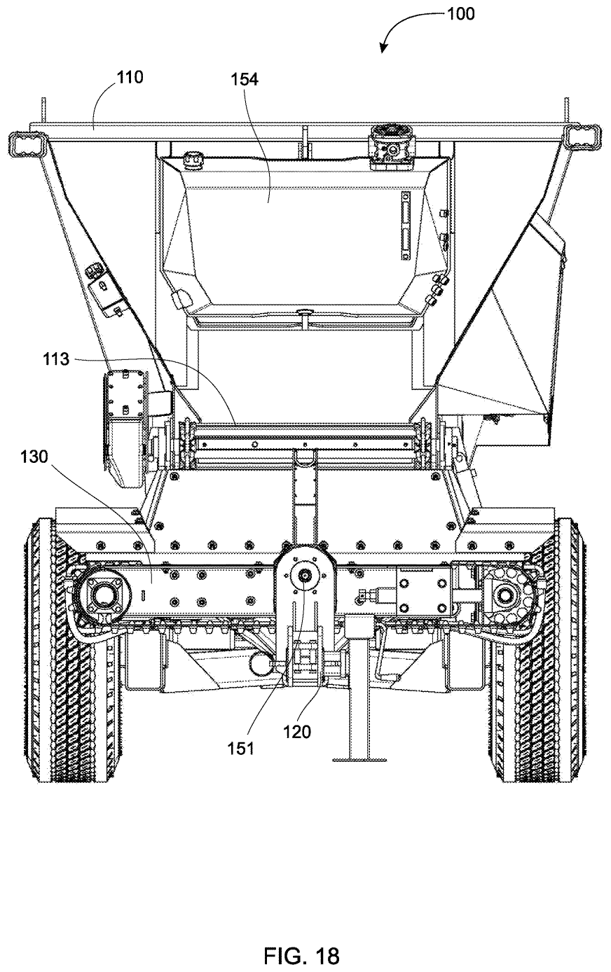

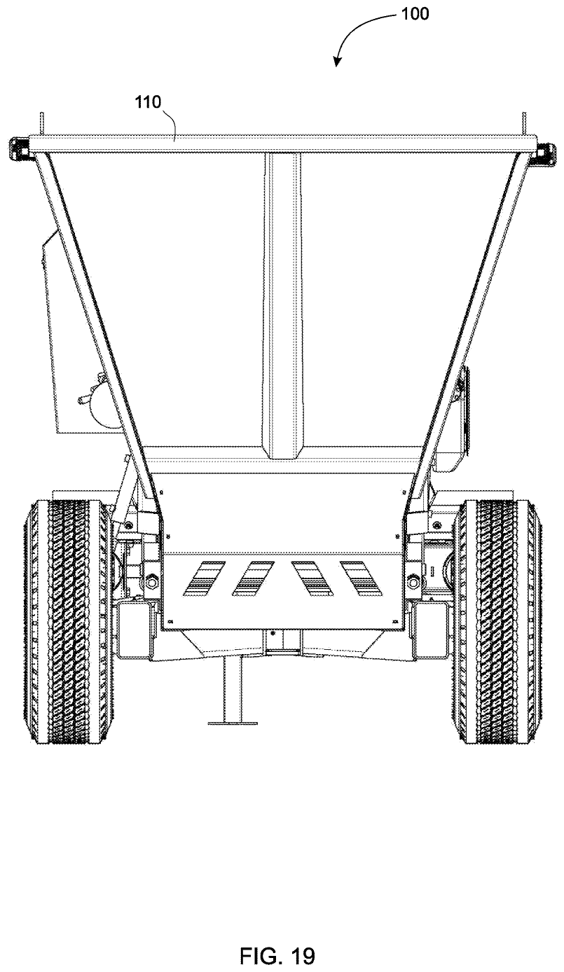

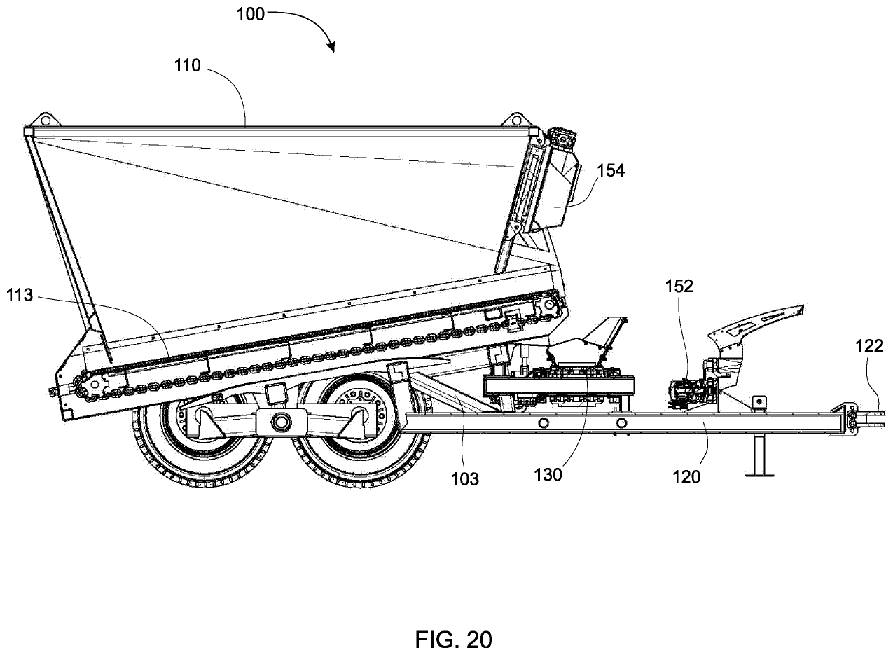

With reference to FIG. 11 to FIG. 20, a second embodiment of a bedding machine 100 for distributing bedding material to a stall is substantially the same as the bedding machine 1 except for a different tongue configuration. The bedding machine 100 comprises a tongue 120 mounted on a frame 103, the tongue 120 extending longitudinally forward in a direction of motion of the bedding machine 100. The tongue 120 comprises a single bar connected to the frame 103, the tongue 120 passing under a distribution conveyor 130, and the tongue 120 terminating in a 1-point hitch 122. A hydraulic pump 152, is mounted on top of the tongue 120. A power-take-off (PTO) shaft (not shown) of a prime mover is operatively connectable to the hydraulic pump 152 through a PTO connector 151 of the hydraulic pump 152 to provide power to the hydraulic pump 152. The PTO shaft has a longitudinal centerline that is above the distribution conveyor 130 during operation of the bedding machine 100. The center of the distribution conveyor 130 is about 3.25 inches below the centerline of the PTO shaft. The hydraulic pump 152 is fluidly connected through hydraulic fluid lines (not shown) to a hydraulic fluid reservoir 154 mounted on an exterior of a hopper 110 and to various hydraulic motors used to operate a conveyor chain in the hopper 110 and the distribution conveyor 130 in a manner similar to the bedding machine 1. As in the bedding machine 1 and as seen in FIG. 20, the bedding machine 100 comprises a live floor 113 that is inclined at an inclination angle, e.g., 10°, away from horizontal. Further, the live floor 113 slopes downward from the front to a rear of the hopper 110.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A bedding machine for distributing bedding material, the bedding machine comprising:
a frame;
wheels rotatably mounted on the frame to permit the bedding machine to travel on the ground;
a hopper supported on the frame, the hopper configured to contain bedding material;
a tongue mounted on the frame extending longitudinally forward of the hopper in a direction of motion of the bedding machine; and,
a distribution conveyor situated below the tongue and pivotably mounted to the frame, to the tongue or to both the frame and the tongue, the distribution conveyor configured to receive the bedding material from the hopper and to distribute the bedding material transversely to the direction of motion of the bedding machine.

2. The bedding machine of claim 1, wherein the distribution conveyor is pivotal about a longitudinal axis so that transverse ends of the conveyor translate up and down.

3. The bedding machine of claim 1, wherein the tongue comprises a pivotable tongue portion that is pivotal about a vertical rotation axis.

4. The bedding machine of claim 1, wherein the wheels comprise tandem wheels and a distance from an end of the tongue to a transverse centerline between the tandem wheels provides articulation of the bedding machine during turning.

5. The bedding machine of any one of claim 1, wherein the bedding machine further comprises a power-take-off extending longitudinally forward of the tongue, the power-take-off having a longitudinal centerline that is above the distribution conveyor during operation of the bedding machine.

6. The bedding machine of claim 1, wherein the tongue comprises a 2-point hitch situated higher from the ground than the distribution conveyor during operation of the bedding machine.

7. The bedding machine of claim 1, wherein the hopper is wider at a front than a rear of the hopper.

8. The bedding machine of claim 1, wherein the hopper comprises an inclined live floor sloping downwardly from a front to a rear of the hopper.

9. The bedding machine of claim 8, wherein the live floor of the hopper is inclined at an angle in a range of 3-7°.

10. The bedding machine of claim 8, wherein the hopper is wider at the front than the rear of the hopper.

11. A bedding machine for distributing bedding material comprises:
a frame;
wheels rotatably mounted on the frame to permit the bedding machine to travel on the ground;
a hopper supported on the frame, the hopper configured to contain bedding material, the hopper comprising an inclined live floor sloping downwardly from a front to a rear of the hopper;
a tongue mounted on the frame extending longitudinally forward of the hopper in a direction of motion of the bedding machine; and,
a distribution conveyor pivotably mounted to the frame, to the tongue or to both the frame and the tongue, the distribution conveyor configured to receive the bedding material from the hopper and to distribute the bedding material transversely to the direction of motion of the bedding machine.

12. The bedding machine of claim 11, wherein the live floor of the hopper is inclined at an angle in a range of 3-15°.

13. The bedding machine of claim 11, wherein the hopper is wider at the front than the rear of the hopper.

14. The bedding machine of claim 11, wherein the distribution conveyor is pivotal about a longitudinal axis so that transverse ends of the conveyor translate up and down.

15. The bedding machine of claim 11, wherein the bedding machine further comprises a power-take-off extending longitudinally forward of the tongue, the power-take-off having a longitudinal centerline that is above the distribution conveyor during operation of the bedding machine.
